(19) United States
(12) Patent Application Publication
(10) Pub. No.: US 2005/0043938 A1
(43) Pub. Date: Feb. 24, 2005

(54) Mutilingual support in web servers for embedded systems

(76) Inventors: Emil Viken, Lillesand (NO); Petter Johnsen, Arendal (NO)

Correspondence Address: ERICSSON INC., 6300 LEGACY DRIVE, M/S EVR C11, PLANO, TX, 75024, US

(21) Appl. No.: 10/491,878

(22) PCT Filed: Aug. 13, 2002
(86) PCT No.: PCT/SE02/01451

(30) Foreign Application Priority Data
Oct. 8, 2001 (NO) 20014884

(51) Int. Cl. G06F 17/20

(52) U.S. Cl. 704/8

(57) ABSTRACT

The present invention discloses a method for making web servers more language independent by scanning the HTML files therein for unique language dependent text phrases and replacing these phrases with unique identities leaving the language independent content unchanged. The unique language dependent text phrases are stored in separate text phrase files. These files are translated into a number of desired browser languages resulting in one set for each language. When receiving a request for a file, the web server scans the file for unique identities, and, if any, fetches the corresponding text phrases from one or more files in the set of files being translated to the language of the browser used by the requesting terminal. Then, the web server provides the requesting terminal with a response comprising the file wherein the found unique identities are replaced by the fetched text phrases. In this way, only one set of IITML pages common for all languages is needed in addition to text phrase files. Thus, no data is repeated, and this allows for integration of web server functionality on memory-limited devices like mobile devices.

### FIELD OF THE INVENTION

The present invention is related to WEB servers, in particular multilingual support in WEB servers for embedded systems.

### BACKGROUND OF THE INVENTION

One of the basic roles in web design is to construct the web pages to be independent of the type of browsers being used by the client terminals, i.e. the web pages on a web server should look similar in e.g. Netscape and Internet Explorer.

To achieve this, web servers generally have one HTML page per language. This makes parts of the HTML files redundant, i.e. scripts, HTML formatting, and other language independent parts are duplicated.

This redundant information is a waste of memory/storage capacity, which is a problem in embedded systems and other systems with limited resources.

The only solution known is to have one set of HTML pages per language the Web Server is supporting.

The problem with the known solution mentioned above is that when there is a set of HTML files translated into different languages, parts of the HTML file content becomes redundant, i.e., scripts, HTML formatting and other language independent parts. This results in a need for more memory/storage capacity, which is a problem in embedded systems and other systems with limited resources.

In the future, mobile terminals/devices will, most likely, contain web server functionality. In such small devices, memory capacity is limited, both due to limited size and memory cost. It is worth mentioning that it is the content (HTML files, pictures, etc.) offered by the web server that is the main factor influencing the need of memory and not the web server application itself. Typical size of a web server designed for an embedded system would be around 30 Kb, while the size of the content offered by the web server could vary a lot, from a few Kb to several hundred Kb.

Thus, the problems mentioned above concerning waste of memory/storage capacity will be even more important to solve.

The multi-lingual functionality described in this document will then help to reduce the size of memory needed to store the content specific elements of the web server.

### SUMMARY OF THE INVENTION

It is an object of the present invention to provide an arrangement that solves the problem described above. The features defined in the independent claims enclosed characterize this method.

In particular, the present invention provides a method for making web servers more language independent by scanning the HTML files therein for unique language dependent text phrases and replacing these phrases with unique identities leaving the language independent content unchanged. The unique language dependent text phrases are stored in separate text phrase files. These files are translated into a number of desired browser languages resulting in one set for each language. When receiving a request for a file, the web server scans the file for unique identities, and, if any, fetches the corresponding text phrases from one or more files in the set of files being translated to the language of the browser used by the requesting terminal. Then, the web server provides the requesting terminal with a response comprising the file wherein the found unique identities are replaced by the fetched text phrases.

### BRIEF DESCRIPTION OF THE DRAWINGS

FIG. 1 is an illustration of the compiling and combining process according to the present invention,

FIG. 2 is a data flow chart showing the signalling at a HTTP client request to a HTTP server supporting the multi lingual functionality according to the present invention,

FIG. 3 shows the multi lingual functionality on a mobile terminal browsed by a PC locally connected thereto,

FIG. 4 shows the multi lingual functionality on a mobile terminal browsed by a PC connected to the terminal via the Internet and a GPRS network.

### DESCRIPTION OF THE PRESENT INVENTION

In the following, a general description of the present invention is disclosed, followed by two example embodiments of how the invention might be implemented.

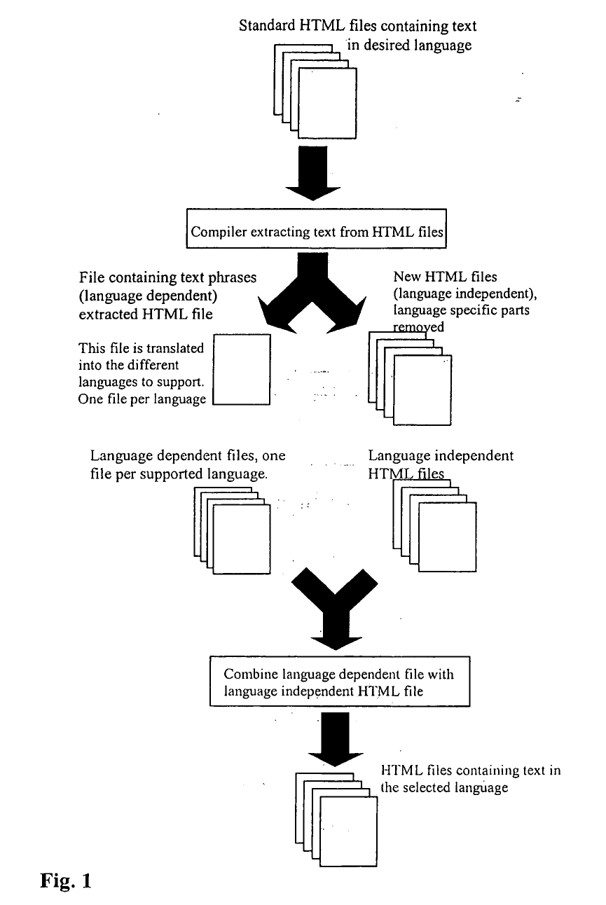

FIG. 1 briefly shows the basic concepts of the present invention. The suggested solution splits the language dependent and independent parts of the HTML file on a web server into two separate files. When an HTML file is accessed, language independent and language dependent parts are combined, and the result will be an HTML file containing formatting and text of the selected language.

To achieve this, the HTML file (of one certain language) must, according to the present invention, be fed into a “language compiler” before it is inserted into the file system of a WEB server. The compiler will read the HTML file and scan for text phrases. The found text phrases will be temporarily stored in a memory for searching for identical text phrases. Note that text and text phrases in this context includes all language dependent file text and commandoes like references to graphics, multi media content, settings (e.g. character set) or simply plain text. Text phrases that have occurred earlier in the search will be deleted to avoid double identity for the same phrase.

Then, a unique phrase identity for each phrase will be generated, and a new HTML file where each text phrase has been replaced by its corresponding unique identity (language independent HTML file) will replace the original file. Simultaneously, the text phrases will be put into a separate text phrase file.

The generated phrase file is sent to a translator that translates the file into desired languages (language dependent phrase files), resulting in one file per language.

Consequently, an HTML page that should be presented in more than one language will then have one HTML file with the texts replaced by unique IDs, and a number of text phrase files (one for each language), all stored in the file system of the web server. In this way, language independent contents will not be repeated for each language.

When a WEB client requests an HTML page, the file system or the WEB server must scan the HTML file for unique text IDs. When a unique ID is found, it will be replaced by the corresponding text from the text phrase file of the selected language, i.e. the language of the browser used by the web client.

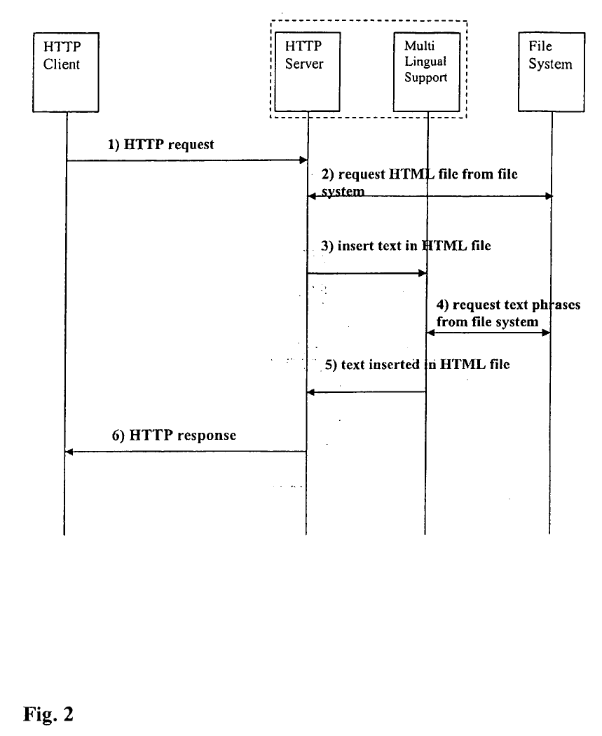

FIG. 2 shows the signalling performed when an HTTP client (web browser) requests an HTML page from the HTTP server (web server) supporting the multi lingual functionality. Referring to the corresponding number of the occurrences in the data flow chart of FIG. 2, the following steps will occur:
1. The web client requests an HTML page from the web server by issuing an HTTP request.
2. The web server processes the request and fetches the requested page from the file system.
3. The web server asks the Multi Lingual support function to scan the HTML page for text identities.
4. The Multi Lingual support function requests text phrases from the file system and replaces the text identities found in the web page.
5. An HTML file updated with text phrases is returned to the web server.
6. The Requested HTML file is returned to the client requesting the page.

The example embodiments described below shows a web server located in a mobile terminal. A prototype of a mobile terminal containing web server functionality has been implemented showing that it is possible to have a web server in such a small device.

As earlier mentioned, mobile terminals/devices will in the future probably contain web server functionality. In the following, we will therefore discuss two example embodiments of the present invention wherein a mobile terminal serves as a web server.

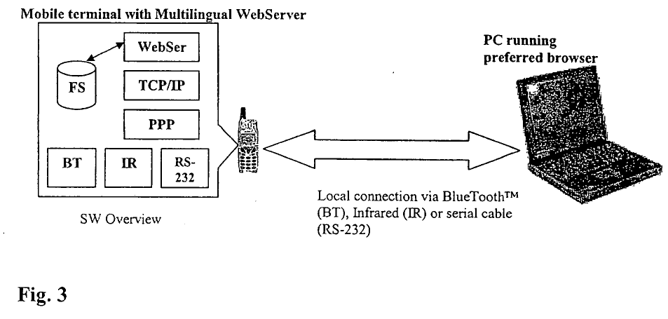

In the first example, illustrated in FIG. 3, the mobile terminal is connected to a PC using a BlueTooth, an Infrared or a Serial-Cable connection.

Dial-up networking is used to establish a connection between the computer and the mobile terminal.

Language independent HTML files and language specific phrase files are stored in the terminal's file system (FS).

When the browser is requesting one of the HTML pages stored in the terminal, the Web Server parses the requested HTML page for text identities and replaces the text identities found with the corresponding text phrases stored in the language specific file before sending the data back to the browser.

The language specific phrase file used is dependent on what language the Web Server is configured to use.

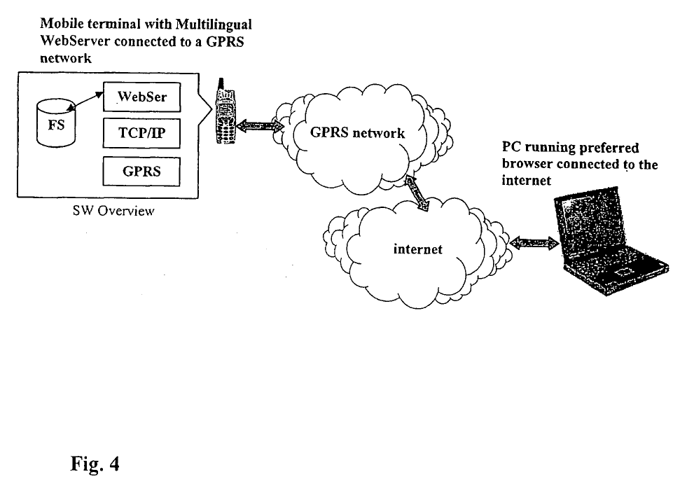

As illustrated in FIG. 4, in the second example of how the present invention may be utilized, the mobile terminal is connected to a GPRS network that has access to the Internet.

The computer used to access the Web Server in the mobile terminal has an Internet connection.

Language independent HTML files and language specific phrase files are stored in the terminal's file system (FS).

When the browser is requesting one of the HTML pages stored in the terminal, the Web Server parses the requested HTML page for text identities and replaces the text identities found with the corresponding text phrases stored in the language specific file before sending the data back to the browser.

The language specific phrase file used is dependent on which language the Web Server is configured to use.

The obvious advantage of this solution compared to the known solution is less use of memory/storage capacity. The reason for this is that only one set of HTML pages common for all languages is needed in addition to text phrase files. In this way, no data is repeated, and this results in no redundant information (HTML formatting, script and other language independent part of an HTML page) in contrast to the solution where it is one set of HTML pages per language supported by the Web Server.

Improved exploitation of memory/storage capacity in web servers will allow for web server functionality to be implemented in small devices like mobile terminals. Because the next generations of mobile communication, like GPRS and UMTS, make the terminals “always” accessible (due to packet switched technology), browsing remotely on such terminals will be possible, and implementation of web server functionality therein will be needed.

The present invention also broadens the limitations for the number of web browsers being compatible for a web server because the effective use of memory/storage capacity will allow the pages to be represented in more languages.

The present invention is not limited to traditional web servers including only HTML adjusted files. The invention may also be applicable in connection with other files related to HTML, like XML files which are compatible with the WAP standard.

1. Method in a server containing source files adjusted for being browsed by remote browsers distributed on one or more terminals directly or indirectly connected to the web server, comprising the steps of:
a) scanning one or more of the files for unique language dependent text phrases,
b) generating one unique identity for each unique text phrase and replacing each text phrase with its corresponding unique identity in one or more new files, each corresponding to one of the source files,
c) storing the unique text phrases in one or more text phrase files.

2. Method according to claim 1, further comprising the step of:
d) translating the text phrases into one or more desired languages resulting in one set of text phrase files for each language.

3. Method according to claim 2, further comprising the step of:
e) when receiving a request from one of the terminals for a source file, scanning the corresponding new file for unique identities, and, if any, fetching the corresponding text phrases from one or more files in the set of files being translated to the language of the browser used by the requesting terminal,
f) providing the requesting terminal with a response comprising the corresponding new file wherein the found unique identities are replaced by the fetched text phrases.

4. Method according to claim 1 wherein that the source files are HTML files.

5. Method according to claim 1 wherein that the web server is a HTTP server, the terminals are HTTP clients and the request is an HTTP request.

6. Method according to claim 1 wherein that the source files are XML files or other files compatible with the WAP standard.

7. Method according to claim 1 wherein that the language dependent text phrases are references to graphics and/or multimedia content, commandoes, settings and/or plain text.

8. Method according to claim 1 wherein said steps are performed by a web server integrated in a mobile device.

9. Method according to claim 8 wherein that the terminals are indirectly connected to the web server integrated within said mobile device through the Internet and/or a GPRS network.

10. Method according to claim 8 wherein that the terminals are locally connected to the web server via a BlueTooth™ link, an infrared link or a serial cable.

11. A web server containing source files adjusted for being browsed by remote browsers distributed on one or more terminals directly or indirectly connected to the web server, comprising:
means for scanning one or more of the files for unique language dependent text phrases,
means for generating one unique identity for each unique text phrase and replacing each text phrase with its corresponding unique identity in one or more new files, each corresponding to one of the source files, and
means for storing the unique text phrases in one or more text phrase files.

12. The web server according to claim 11, further comprising means for translating the text phrases into one or more desired languages resulting in one set of text phrase files for each language.

13. The web server according to claim 12, further comprising:
when receiving a request from one of the terminals for a source file, means for scanning the corresponding new file for unique identities, and, if any, fetching the corresponding text phrases from one or more files in the set of files being translated to the language of the browser used by the requesting terminal, and
means for providing the requesting terminal with a response comprising the corresponding new file wherein the found unique identities are replaced by the fetched text phrases.

14. The web server of claim 11 wherein the source files are HTML files.

15. The web server of claim 11 wherein that the web server is a HTTP server, the terminals are HTTP clients and the request is an HTTP request.

16. The web server of claim 11 wherein that the source files are XML files or other files compatible with the WAP standard.

17. The web server of claim 11 wherein that the language dependent text phrases are references to graphics and/or multimedia content, commandoes, settings and/or plain text.

18. The web server of claim 11 wherein said means are integrated in a mobile devices.

19. The web server of claim 18 wherein the terminals are indirectly connected to the web server integrated within said mobile device through the Internet and/or a GPRS network.

20. The web server of claim 18 wherein that the terminals are locally connected to the web server via a BlueTooth link, an infrared link or a serial cable.
